(19) United States
(12) Patent Application Publication
(10) Pub. No.: US 2026/0124994 A1
(43) Pub. Date: May 7, 2026

(54) STORAGE DEVICE AND STORAGE STRUCTURE

(71) Applicant: TOYODA GOSEI CO., LTD., Kiyosu-shi (JP)

(72) Inventor: Kohei YOSHIDA, Kiyosu-shi (JP)

(21) Appl. No.: 19/372,935

(22) Filed: Oct. 29, 2025

(30) Foreign Application Priority Data
Nov. 7, 2024 (JP) 2024-195252

(51) Int. Cl. B60R 7/00

(52) U.S. Cl. CPC B60R 7/00

(57) ABSTRACT

In an attachment state where a storage device 2 mounted in a vehicle compartment and located on a rear side in a first direction with respect to an attachment counterpart 5 integrated with a vehicle body is attached to the attachment counterpart 5,

a first fixing part 31 of the storage device 2 sandwiches a peripheral portion of a first fixing counterpart 51 of the attachment counterpart 5 in the first direction,

a fastening hole 32H of a second fixing part 32 of the storage device 2 faces a second fixing counterpart 52 of the attachment counterpart 5 in a second direction, and

a peripheral portion of the fastening hole 32H of the second fixing part 32 and a peripheral portion of the second fixing counterpart 52 are fastened together in the second direction by a fastener 4.

### TECHNICAL FIELD

The present disclosure relates to a storage device and a storage structure mounted on a vehicle.

### BACKGROUND ART

Various storage devices such as a console box are mounted on a vehicle. The storage devices are each a vehicular interior component for storing luggage therein and are each typically formed as a component separate from the vehicle body of a vehicle and installed in the interior of the vehicle by being attached to the vehicle body (see, for example, JP2021-79826 (A)).

For example, when the vehicle travels on a rough road, when the vehicle is suddenly braked, or when an impact such as a collision occurs, a large external force acts on the vehicle. To withstand such an external force, storage devices such as a console box are firmly attached to the vehicle body.

JP2021-79826 (A) introduces a console box as a storage device.

In the console box introduced in JP2021-79826 (A), a rear center console 2 is directly fixed to a floor panel 1 of a vehicle body at a storage part 22, which is a part of the rear center console 2, using a fastener 24 and is fixed to the vehicle body at a front center console 21, which is another part of the rear center console 2, via a console bracket 3.

Accordingly, the console box introduced in JP2021-79826 (A) is firmly fixed to the vehicle body.

### SUMMARY OF INVENTION

### TECHNICAL PROBLEM

Meanwhile, as described above, storage devices such as a console box are required to be firmly attached to the vehicle body so as to withstand an external force when an impact occurs.

Conventionally, in order to stably fix a console box to a vehicle body, as an attachment structure for attaching the console box to the vehicle body, fasteners such as a combination of a bolt and a nut are selected, and the console box is fastened and fixed to the vehicle body at many points.

However, the console box is relatively large among vehicular interior components, thus the work of fastening the console box to the vehicle body at many points is cumbersome, and there is a problem of high cost for the attachment work for attaching the console box to the vehicle.

For example, as for the console box introduced in JP2021-79826 (A), the console box is divided into multiple separate parts, and each separate part is fixed separately to the vehicle body.

Specifically, the console box introduced in JP2021-79826 (A) is roughly divided into two separate parts, the rear center console 2 which is mainly responsible for a storage function and the console bracket 3 which is responsible for a function of serving as an attachment portion to the vehicle body.

In this console box, the storage part 22, having a particularly large mass, of the rear center console 2 is directly fastened to the floor panel 1, which is a part of the vehicle body, using the fastener 24.

In addition, in the console box, the front center console 21, which is another part of the rear center console 2, is fixed to the floor panel 1 via the console bracket 3.

By attaching the separate parts of the console box (i.e., the storage part 22 and the console bracket 3 to which the front center console 21 is attached) separately to the vehicle body as described above, the work of attaching the console box to the vehicle body is considered to be easier compared to the case of attaching a large console box to the vehicle body.

However, on the other hand, the work of fixing each separate part separately to the vehicle body is still cumbersome, and many attachment structures such as fasteners are required in order to fix each separate part separately to the vehicle body.

In particular, in order to fix the front center console 21 to the floor panel 1 by the method in Cited Literature 1, many steps including fixing the front center console 21 to the console bracket 3 using clips 6 and then fixing the console bracket 3 to the floor panel 1 using bolts 4 and nuts 5, are required.

As described above, conventionally, in order to stably fix the console box to the vehicle body, many attachment structures are required, and as a result, the attachment work of fixing the console box to the vehicle body is very cumbersome.

The present disclosure has been made in view of the above circumstances, and an object of the present disclosure is to provide a technique for stably and easily fixing a storage device such as a console box to a vehicle body.

### SOLUTION TO PROBLEM

A storage structure of the present disclosure for achieving the above object is a storage structure mounted in a vehicle compartment, the storage structure including

an attachment counterpart integrated with a vehicle body and a storage device located on a rear side in a first direction with respect to the attachment counterpart, wherein

the storage device has a body part having a box shape, a fixing part protruding from a bottom wall, located on a front side in the first direction, of the body part, and a fastener,

the fixing part has a first fixing part and a second fixing part spaced apart from the first fixing part in a second direction intersecting the first direction and having a fastening hole with an opening facing in the second direction,

the attachment counterpart has a first fixing counterpart having a through hole shape with an opening facing in the first direction and a second fixing counterpart having a hole shape with an opening facing in the second direction and spaced apart from the first fixing counterpart in the second direction, and

in an attachment state where the storage device is attached to the attachment counterpart,

the first fixing part sandwiches a peripheral portion of the first fixing counterpart in the first direction,

the fastening hole of the second fixing part faces the second fixing counterpart in the second direction, and

a peripheral portion of the fastening hole of the second fixing part and a peripheral portion of the second fixing counterpart are fastened together in the second direction by the fastener.

A storage device of the present disclosure for achieving the above object is a storage device mounted in a vehicle compartment and located on a rear side in a first direction with respect to an attachment counterpart integrated with a vehicle body, wherein

the attachment counterpart has a first fixing counterpart having a through hole shape with an opening facing in the first direction and a second fixing counterpart having a hole shape with an opening facing in a second direction intersecting the first direction and spaced apart from the first fixing counterpart in the second direction,

the storage device has a body part having a box shape, a fixing part protruding from a bottom wall, located on a front side in the first direction, of the body part, and a fastener,

the fixing part has a first fixing part and a second fixing part spaced apart from the first fixing part in the second direction and having a fastening hole with an opening facing in the second direction, and

in an attachment state where the storage device is attached to the attachment counterpart,

the first fixing part sandwiches a peripheral portion of the first fixing counterpart of the attachment counterpart in the first direction,

the fastening hole of the second fixing part faces the second fixing counterpart of the attachment counterpart in the second direction, and

a peripheral portion of the fastening hole of the second fixing part and a peripheral portion of the second fixing counterpart are fastened together in the second direction by the fastener.

### ADVANTAGEOUS EFFECTS OF INVENTION

According to the storage structure and the storage device of the present disclosure, the storage device is allowed to be stably and easily fixed to the vehicle body.

### BRIEF DESCRIPTION OF DRAWINGS

FIG. 1 schematically illustrates a storage structure of an embodiment;

FIG. 2 schematically illustrates the storage structure of the embodiment;

FIG. 3 schematically illustrates an attachment counterpart and a fixing part in the storage structure of the embodiment;

FIG. 4 schematically illustrates the attachment counterpart and the fixing part in the storage structure of the embodiment; and

FIG. 5 schematically illustrates the positional relationship between the attachment counterpart, the fixing part, and reinforcing ribs in the storage structure of the embodiment.

### DESCRIPTION OF EMBODIMENTS

A storage device of the present disclosure and a storage device in a storage structure of the present disclosure are located on a rear side in a first direction with respect to an attachment counterpart integrated with a vehicle body (or integrated with a vehicle). The attachment counterpart may be a part of the vehicle body, and, for example, at least a part of a floor panel corresponds to this attachment counterpart.

The storage device has a body part having a box shape, a fixing part protruding from a bottom wall, of the body part, which is located on a front side in the first direction described above, and a fastener and is attached to the attachment counterpart by the fixing part and the fastener.

In the conventional art described above, the console box, which is a storage device, is divided into multiple separate parts, that is, the storage part 22 and the console bracket 3 to which the front center console 21 is attached, and these are separately fixed to the vehicle body.

In contrast, in the storage device and the storage structure of the present disclosure, the storage device itself has the fixing part and the fastener for fixing the storage device to the vehicle body.

That is, in the storage device and the storage structure of the present disclosure, the function of a console bracket is integrated into the storage device. Accordingly, with the storage device and the storage structure of the present disclosure, a step of attaching a console bracket to the storage device is omitted, and the man-hours are also reduced compared to the case of assembling a housing and a console bracket in the storage device to the vehicle body.

Furthermore, by integrating the function of a console bracket into the storage device, an attachment structure for attaching a console bracket to the storage device is eliminated, and the number of attachment structures for separately attaching a housing and a console bracket in the storage device to the vehicle body is reduced. Therefore, the storage device and the storage structure of the present disclosure also have an advantage of reducing the number of components in the storage device.

Furthermore, in the storage device and the storage structure of the present disclosure, the fixing part of the storage device has a first fixing part and a second fixing part. In an attachment state where the storage device is attached to the attachment counterpart, the first fixing part sandwiches a peripheral portion of a first fixing counterpart of the attachment counterpart in the first direction, and the second fixing part faces a second fixing counterpart of the attachment counterpart in a second direction intersecting the first direction. A peripheral portion of a fastening hole of the second fixing part and a peripheral portion of the second fixing counterpart are then fastened together in the second direction by the fastener.

In other words, in the storage device and the storage structure of the present disclosure, the storage device is fixed to the attachment counterpart in two different directions. Therefore, the storage device is stably fixed to the attachment counterpart, withstanding external forces acting from various directions.

Moreover, in the storage device and the storage structure of the present disclosure, the first fixing part and the first fixing counterpart are engaged with each other, and the peripheral portion of the fastening hole of the second fixing part and the peripheral portion of the second fixing counterpart are fastened together by the fastener. In other words, in the storage device and the storage structure of the present disclosure, a part of the attachment structure for attaching the storage device to the vehicle body is configured as an engagement structure, and the rest of the attachment structure is configured as a fastening structure including the fastener.

Therefore, in the storage device and the storage structure of the present disclosure, compared to the case where the attachment structure for the storage device and the vehicle body is composed of only fasteners, the number of components in the attachment structure is reduced, so that the work for attaching the storage device to the attachment counterpart becomes easy.

Therefore, in the storage device and the storage structure of the present disclosure, even if the storage device is not divided into separate parts, the storage device is allowed to be stably and easily fixed to the vehicle body.

Owing to the cooperation of these, according to the storage structure and the storage device of the present disclosure, the storage device is allowed to be stably and easily fixed to the vehicle body. In addition, since the above attachment work is easy and the number of components in the attachment structure is small, the storage structure and the storage device of the present disclosure are also advantageous in terms of manufacturing costs.

As described above, in the storage device and the storage structure of the present disclosure, the storage device is stably and easily fixed to the vehicle body even if the storage device is not divided into separate parts. Therefore, the present disclosure is considered to be particularly useful in the case where the storage device is a large one such as a console box.

Hereinafter, the storage device and the storage structure of the present disclosure will be described for each constituent element thereof.

Unless otherwise specified, a numerical range “x to y” described herein includes, in the range thereof, the lower limit x and the upper limit y. A new numerical range may be formed by optionally combining these upper and lower limit values and numerical values described in embodiments. Numerical values optionally selected from any of the numerical ranges may be used as the upper and lower limit values in a new numerical range.

The storage structure of the present disclosure includes a storage device and an attachment counterpart, and the storage device corresponds to the storage device of the present disclosure.

Therefore, hereinafter, when the storage device of the present disclosure is mentioned without further explanation, this storage device collectively refers to the storage device of the present disclosure and the storage device in the storage structure of the present disclosure. The same applies to the case where a storage device, a storage device of an embodiment, or the like is mentioned without further explanation.

As previously described, the storage structure of the present disclosure includes an attachment counterpart and a storage device.

The attachment counterpart is integrated with a vehicle body.

A method for integrating the attachment counterpart with the vehicle body in the storage device of the present disclosure is not particularly limited.

For example, the attachment counterpart may be integrally molded with a part of the vehicle body, such as a floor panel, or the entirety of the vehicle body, or may be molded separately from a part or the entirety of the vehicle body and fixed thereto by a method such as fastening or welding.

The material of the attachment counterpart is not particularly limited but is preferably a material having excellent strength and rigidity and is more preferably a metal such as iron or stainless steel or a fiber reinforced plastic such as glass fiber reinforced plastic (GFRP) or carbon fiber reinforced plastic (CFRP). Particularly preferably, the material of the attachment counterpart is the same as the material of the vehicle body.

The storage device is attached to the attachment counterpart. Therefore, the attachment counterpart is also considered to be another portion of the vehicle body, in other words, a portion interposed between a general portion of the vehicle body and the storage device.

Such an attachment counterpart also functions as an attachment structure for attaching the storage device to the vehicle body.

Specifically, the attachment counterpart has a first fixing counterpart and a second fixing counterpart to which the storage device is attached. The first fixing counterpart is a part to which the first fixing part of the storage device described later is attached. In addition, the second fixing counterpart is a part to which the second fixing part of the storage device described later is attached.

The first fixing counterpart has a through hole shape with an opening facing in the first direction described later. In addition, the second fixing counterpart has a hole shape with an opening facing in the second direction described later. The second fixing counterpart is spaced apart from the first fixing counterpart in the second direction described later. In other words, the second fixing counterpart is spaced apart from the first fixing counterpart in the direction in which the opening thereof faces.

The shapes and the positions of the first fixing counterpart and the second fixing counterpart may be set as appropriate according to the shapes and the positions of the first fixing part and the second fixing part described later.

The storage device is located on the rear side in the first direction with respect to the attachment counterpart. Here, the first direction is not particularly limited, and the relationship between the front side and the rear side is also not particularly limited. The first direction, the front side in the first direction, and the rear side in the first direction are determined as appropriate according to the attachment position of the storage device with respect to the vehicle body.

For example, in the case where the first direction is the up-down direction, the rear side of the first direction may be the upper side or the lower side.

Specifically, in the case where the attachment counterpart is integrated with the floor panel of the vehicle body, the storage device is located above the floor panel. In this case, the first direction is the up-down direction, the front side in the first direction is the lower side, and the rear side in the first direction is the upper side.

Moreover, in the case where the attachment counterpart is integrated with a roof panel of the vehicle body, the storage device is located below the roof panel. In this case, the first direction is the up-down direction, the front side in the first direction is the upper side, and the rear side in the first direction is the lower side.

Furthermore, for example, in the case where the first direction is the vehicle width direction, the rear side in the first direction is preferably the inner side of the vehicle compartment.

Specifically, in the case where the attachment counterpart is integrated with a door panel or a center pillar of the vehicle body, the storage device is located on the inner side of the vehicle compartment with respect to the door panel or the center pillar. In this case, the first direction is the vehicle width direction, the front side in the first direction is the outer side of the vehicle compartment, and the rear side in the first direction is the inner side of the vehicle compartment.

Furthermore, when the first direction is the vehicle traveling direction, preferably, the front side in the first direction is the front side in the vehicle traveling direction and the rear side in the first direction is the rear side in the vehicle traveling direction.

For example, when the attachment counterpart is integrated with a front pillar of the vehicle body, the storage device is located on the rear side in the vehicle traveling direction with respect to the front pillar. In this case, the first direction is the vehicle traveling direction, the front side in the first direction is the front side in the vehicle traveling direction, and the rear side in the first direction is the rear side in the vehicle traveling direction.

The storage device of the present disclosure has a body part, a fixing part, and a fastener.

The body part has a box shape. The body part having a box shape is a part, of the storage device, which is responsible for a function of accommodating items therein, and is considered to be a main body of the storage device.

The fixing part is a part, of the storage device, which is responsible for a function of serving as an attachment structure with respect to the attachment counterpart.

The fixing part protrudes from the bottom wall, of the body part, which is located on the front side in the first direction. In other words, the fixing part extends from a portion, of the body part, which faces the attachment counterpart, further toward the attachment counterpart side.

The fixing part has a first fixing part and a second fixing part, and the second fixing part is spaced apart from the first fixing part in a second direction. The second direction is a direction intersecting the first direction described above and is also a direction in which the peripheral portion of the fastening hole of the second fixing part and the peripheral portion of the second fixing counterpart are fastened together as described later.

The second direction only needs to be a direction intersecting the first direction, and may intersect the first direction at any angle, but in order to be able to withstand external forces acting from various directions when an impact occurs, the intersection angle between the first direction and the second direction is preferably close to a right angle.

Specifically, the intersection angle between the first direction and the second direction is preferably within the range of 70° to 110°, within the range of 80° to 100°, or within the range of 85° to 95°.

In the attachment state where the storage device of the present disclosure is attached to the attachment counterpart, the first fixing part is fixed to the attachment counterpart by sandwiching the peripheral portion of the first fixing counterpart of the attachment counterpart in the first direction.

Such a first fixing part only needs to have a shape that allows the first fixing part to sandwich the peripheral portion of the first fixing counterpart in the first direction.

An example of the first fixing part capable of sandwiching the peripheral portion of the first fixing counterpart in the first direction is specifically a part having two portions (front portion and rear portion) spaced apart in the first direction.

The front portion is a portion located on the front side in the first direction with respect to the peripheral portion of the first fixing counterpart in the attachment state, and the rear portion is a portion located on the rear side in the first direction with respect to the peripheral portion of the first fixing counterpart in the attachment state. Such a first fixing part is capable of sandwiching the peripheral portion of the first fixing counterpart between the front portion and the rear portion which are spaced apart from each other in the first direction.

Hereinafter, the peripheral portion of the first fixing counterpart is sometimes referred to as first peripheral counterpart, if necessary. Furthermore, a portion, of the first fixing part, which is located between the front portion and the rear portion in the first direction is sometimes referred to as fixing middle portion, if necessary.

When the first fixing part, which has the front portion, the fixing middle portion, and the rear portion, is attached to the first fixing counterpart and fixed to the attachment counterpart, the fixing middle portion is fitted into the first fixing counterpart, which has a through hole shape, and the first peripheral counterpart is sandwiched between the front portion and the rear portion.

Therefore, the outer diameter of the first fixing part, which has the front portion and the rear portion described above, becomes smaller at the fixing middle portion than those of the front portion and the rear portion. The outer diameter of the front portion and the outer diameter of the rear portion may be different or the same.

The mode in which the front portion and the rear portion of the first fixing part sandwich the above-described first peripheral counterpart therebetween may be any mode. Examples of a preferable mode in which the front portion and the rear portion of the first fixing part sandwich the above-described first peripheral counterpart therebetween include the following Mode [1], Mode [2], and Mode [3].

Mode [1]: The first fixing part engages the first fixing counterpart by sliding linearly in a direction intersecting the first direction, with respect to the first fixing counterpart.

Mode [2]: The first fixing part engages the first fixing counterpart by sliding in a rotational direction with respect to the first fixing counterpart.

Mode [3]: The first fixing part is press-fitted into the first fixing counterpart.

First, Mode [1], that is, the mode in which the first fixing part engages the first fixing counterpart by sliding linearly in the direction intersecting the first direction, with respect to the first fixing counterpart, will be described. The “direction intersecting the first direction” in this case is referred to as linear sliding direction, if necessary.

In Mode [1] above, the first fixing counterpart preferably has an elongated hole shape extending along the linear sliding direction. The first fixing counterpart, which has such an elongated hole shape, is capable of guiding the sliding direction of the first fixing part in the above linear sliding direction. Accordingly, there is an advantage of improving the workability of attaching the storage device to the attachment counterpart.

In this case, a rear portion in the linear sliding direction of the first fixing counterpart, that is, a portion, of the first fixing counterpart, into which the first fixing part is inserted, preferably has a diameter that is larger than the outer diameter of the front portion of the first fixing part and is larger than that of a portion of the first fixing counterpart on the front side with respect to this portion. Hereinafter, the rear portion in the linear sliding direction of the first fixing counterpart is sometimes referred to as insertion port of the first fixing counterpart or simply as insertion port, if necessary.

When the insertion port of the first fixing counterpart has a diameter that is larger than the outer diameter of the rear portion of the first fixing part and is larger than that of the portion of the first fixing counterpart on the front side with respect to the insertion port, there is an advantage of being able to easily insert the front portion and the fixing middle portion of the first fixing part into the first fixing counterpart. In addition, in this case, by sliding the first fixing part along the above-described linear sliding direction with respect to the first fixing counterpart, the first peripheral counterpart is easily sandwiched between the front portion and the rear portion with the fixing middle portion accommodated inside the first fixing counterpart, which has a through hole shape. That is, in this case, there is an advantage of being able to easily engage the first fixing part and the first fixing counterpart with each other.

In this Mode [1], the shapes of the front portion and the rear portion are not particularly limited. For example, at least one of the front portion and the rear portion may have a circular column shape, conical shape, frustoconical shape, or the like that have a cross-section having a perfect circle shape centered in the first direction. Alternatively, at least one of the front portion and the rear portion may have a polygonal column shape, polygonal pyramid shape, polygonal frustum shape, or the like that have a cross-section centered in the first direction.

Alternatively, at least one of the front portion and the rear portion may have a shape extending in the second direction, in other words, an elongated shape having a longitudinal direction oriented in the second direction.

In this case, the length by which the front portion or the rear portion overlaps with the first peripheral counterpart is made sufficiently long, so that there is an advantage of being able to stably sandwich the first peripheral counterpart between the front portion and the rear portion to firmly engage the first fixing part and the first fixing counterpart with each other.

In order to more firmly engage the first fixing part and the first fixing counterpart with each other, both the front portion and the rear portion preferably have the above-described shape extending in the second direction.

In the case where both the front portion and the rear portion have a shape extending in the second direction, preferably, the distance between the front portion and the rear portion in the first direction gradually shortens from the front side toward the rear side in the second direction. In this case, when the first fixing part is slid with respect to the first fixing counterpart from the rear side toward the front side in the second direction in a state where the front portion is inserted into the first fixing counterpart, the first peripheral counterpart is elastically sandwiched between the front portion and the rear portion in the first direction, so that there is an advantage of being able to easily and firmly engage the first fixing part and the first fixing counterpart with each other.

In this case, the shortest distance between the front portion and the rear portion in the first direction in a natural state is preferably equal to or less than the thickness of the first peripheral counterpart in the first direction and is more preferably equal to or less than 95%, 90%, or 85% of this thickness. Here, the natural state means a state where the first fixing part is not engaged with the first fixing counterpart.

In this Mode [1], the second direction, that is, the direction in which the first fixing part is slid, may be set to any direction, but a relatively large working space is required in order to slide the first fixing part and, consequently, the storage device having the first fixing part. Therefore, in this Mode [1], the second direction is particularly preferably a direction that coincides with the longitudinal direction of the vehicle. In many vehicles, the longitudinal direction thereof generally coincides with the vehicle traveling direction. Therefore, the second direction particularly preferably coincides with the vehicle traveling direction. The direction in which the first fixing part is slid may be a direction from the rear side toward the front side in the vehicle traveling direction or may be a direction from the front side toward the rear side in the vehicle traveling direction. In other words, the front side in the second direction may be the front side or the rear side in the vehicle traveling direction.

Furthermore, in this case, if the second fixing part is located on the rear side in the second direction with respect to the second fixing counterpart, when the peripheral portion of the fastening hole in the second fixing part and the peripheral portion of the second fixing counterpart are fastened together in the second direction by the fastener during the attachment work, the second fixing part is pushed to the front side in the second direction, whereby the storage device itself is pushed to the front side in the second direction. At this time, a force directed to the front side in the second direction also acts on the first fixing part. Therefore, for example, even if the sliding amount of the first fixing part toward the front side in the second direction is not sufficient during the work of attaching the first fixing part and the first fixing counterpart and the engagement length of the first fixing part with the peripheral portion of the first fixing counterpart is not sufficient, the first fixing part slides toward the front side in the second direction during the work of attaching the second fixing counterpart and the second fixing part. Accordingly, the above engagement length becomes sufficient, so that there is an advantage of being able to engage the first fixing part and the first fixing counterpart with sufficient strength.

Mode [2], that is, the mode in which the first fixing part engages the first fixing counterpart by sliding in the rotational direction with respect to the first fixing counterpart, will be described.

In the above Mode [2], the first fixing counterpart preferably has a keyhole shape with a portion thereof having a larger hole diameter than the rest. The outer shape of the front portion of the first fixing part is preferably a key shape complementary to this keyhole.

In the case where the first fixing counterpart has a keyhole shape and the front portion of the first fixing part has a key shape as described above, the peripheral portion of the first fixing counterpart is easily sandwiched between the front portion and the rear portion by rotating the first fixing part with respect to the first fixing counterpart with the first direction as an axial direction in a state where the front portion is inserted into the first fixing counterpart and the fixing middle portion is accommodated inside the first fixing counterpart which has a through hole shape. Therefore, in this case as well, there is an advantage of being able to easily engage the first fixing part and the first fixing counterpart with each other.

Mode [3], that is, the mode in which the first fixing part is press-fitted into the first fixing counterpart, will be described.

In the above Mode [3], the hole diameter of the first fixing counterpart only needs to be smaller than the outer diameter of the front portion and the outer diameter of the rear portion of the first fixing part. The difference between the hole diameter of the first fixing counterpart and each of the outer diameter of the front portion and the outer diameter of the rear portion of the first fixing part may be set as appropriate in consideration of the workability of attaching the first fixing part to the first fixing counterpart and the attaching strength of the storage device to the attachment counterpart.

The hole diameter of the first fixing counterpart in this case may be larger than the outer diameter of the fixing middle portion, may be the same as the outer diameter of the fixing middle portion, or may be smaller than the outer diameter of the fixing middle portion. Considering the workability of attaching the first fixing part to the first fixing counterpart, the press-fitting load applied when press-fitting the first fixing part into the first fixing counterpart is preferably smaller, and the hole diameter of the first fixing counterpart is preferably equal to or larger than the outer diameter of the fixing middle portion.

The fixing part of the storage device of the present disclosure has a second fixing part in addition to the first fixing part described above.

The second fixing part is spaced apart from the first fixing part in the second direction and has a fastening hole with an opening facing in the second direction, and is a part that faces the second fixing counterpart of the attachment counterpart in the second direction and is fastened in the second direction by a fastener in the attachment state.

The shapes of the second fixing part of the fixing part and the second fixing counterpart of the attachment counterpart may be set as appropriate according to the type of the fastener.

The second fixing counterpart of the attachment counterpart only needs to have a hole shape with an opening facing in the second direction and may have a through hole shape or a blind hole shape.

Similarly, the second fixing part of the fixing part also only needs to have a fastening hole shape with an opening facing in the second direction and may have a through hole shape or a blind hole shape.

For example, in the case where the fastener is composed of a bolt and a nut, the fastening hole and the second fixing counterpart only need to have a through hole shape. In this case, by the nut being screwed onto the bolt that has penetrated the fastening hole and the second fixing counterpart, the peripheral portion of the fastening hole of the second fixing part and the peripheral portion of the second fixing counterpart are fastened together in the second direction by the fastener.

Moreover, for example, in the case where the fastener is a screw, at least one of the fastening hole and the second fixing counterpart only needs to be a hole having a thread that is formed on an inner circumferential surface thereof and to which the screw is screwed.

For example, when the screw as the fastener is inserted from the second fixing part side to the second fixing counterpart side, screwing of the screw that has penetrated the fastening hole, to the inner circumferential surface of the second fixing counterpart is necessary. Therefore, in this case, the fastening hole needs to be a through hole, and the second fixing counterpart may be a through hole or a blind hole. Furthermore, in this case, the above thread needs to be formed on the inner circumferential surface of the second fixing counterpart, and a thread may or may not necessarily be formed on the inner circumferential surface of the fastening hole.

In addition, for example, when the screw as the fastener is inserted from the second fixing counterpart side to the second fixing part side, screwing of the screw that has penetrated the second fixing counterpart, to the inner circumferential surface of the fastening hole is necessary. Therefore, in this case, the second fixing counterpart needs to be a through hole, and the fastening hole may be a through hole or a blind hole. Furthermore, in this case, the above thread needs to be formed on the inner circumferential surface of the fastening hole, and a thread may or may not necessarily be formed on the inner circumferential surface of the second fixing counterpart.

The inner circumferential surface of the fastening hole or the second fixing counterpart is considered to be the peripheral portion of the fastening hole or the second fixing counterpart. Therefore, in these cases as well, the peripheral portion of the fastening hole and the peripheral portion of the second fixing counterpart are considered to be fastened together in the second direction by the fastener.

The fastener only needs to be a fastener capable of fastening the peripheral portion of the fastening hole and the peripheral portion of the second fixing counterpart, and may be a combination of a bolt and a nut as described above, may be a screw (so-called wood screw), or may be a fastener capable of generating an anchoring effect such as a bolt plug, an anchor bolt, or a pin anchor.

Hereinafter, the storage device and the storage structure of the present disclosure will be described by means of a specific example.

### Embodiment

A storage device of an embodiment is a console box, and a storage structure of the embodiment is a console box structure that includes the console box of the embodiment and an attachment counterpart. The attachment counterpart is a part of a floor panel in a vehicle body.

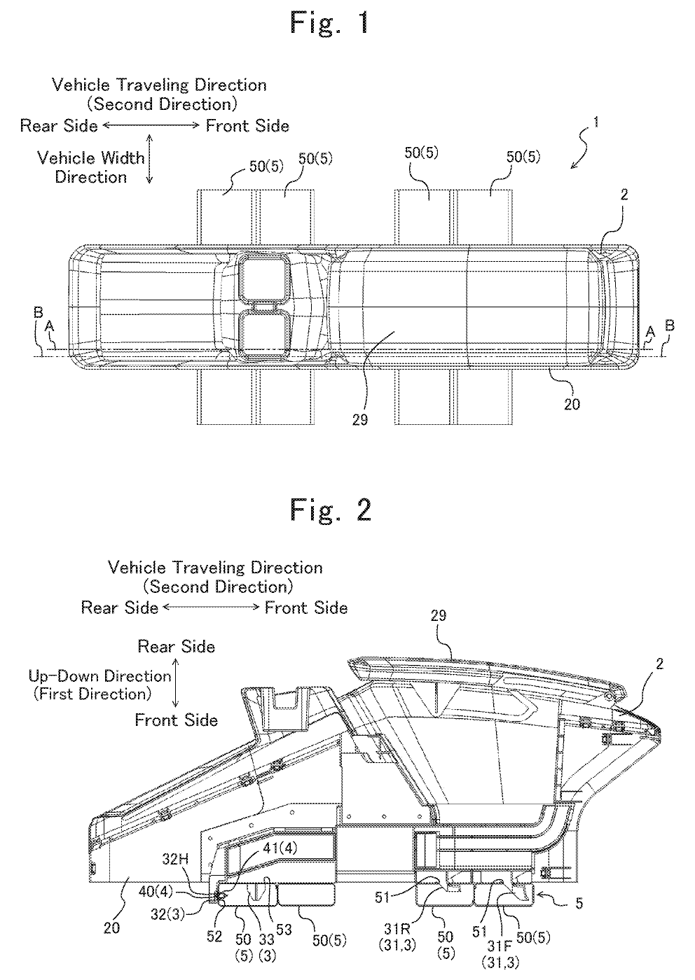

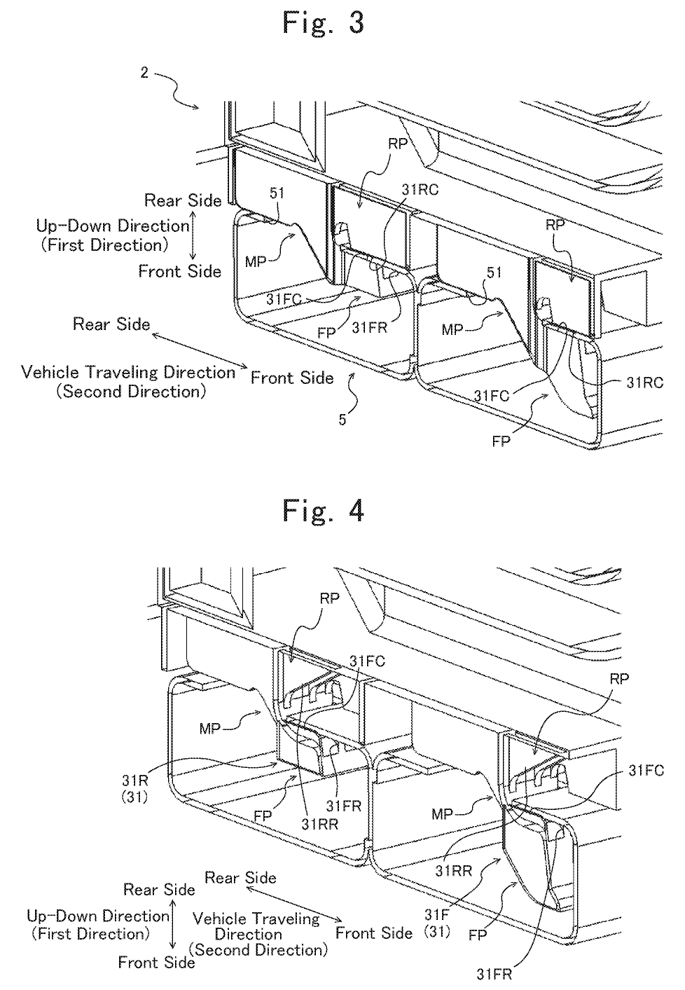

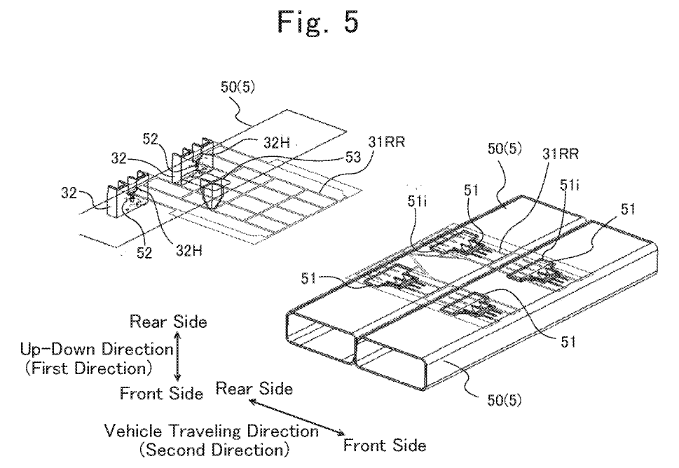

A schematic illustration of the console box structure of the embodiment is shown in FIG. 1 and FIG. 2. FIG. 1 schematically illustrates a situation where the console box structure of the embodiment is viewed from above, and FIG. 2 schematically illustrates a situation where a cross-section of the console box structure of the embodiment at a position A-A in FIG. 1 is viewed from a lateral side. FIG. 3 and FIG. 4 schematically illustrate the attachment counterpart and a fixing part in the console box structure of the embodiment. FIG. 3 schematically illustrates a situation where a cross-section of the console box structure of the embodiment at a position B-B in FIG. 1 is viewed from above and the lateral side. FIG. 4 schematically illustrates a situation where the cross-section of the console box structure of the embodiment at the position A-A in FIG. 1 is viewed from above and the lateral side. FIG. 5 schematically illustrates the positional relationship between the attachment counterpart, the fixing part, and reinforcing ribs in the console box structure of the embodiment.

As shown in FIG. 1, a console box structure 1 of the embodiment has a console box 2 and an attachment counterpart 5.

The attachment counterpart 5 is a part of the floor panel in the vehicle body, is made of the same metal as a floor panel body part (not shown), and is formed separately from the floor panel body part.

The attachment counterpart 5 is integrated with the floor panel body part by being fastened to the floor panel body part by bolts and nuts which are not shown.

As shown in FIG. 1 and FIG. 2, the console box 2 is located above the attachment counterpart 5. Therefore, in the console box structure 1 of the embodiment, the up-down direction is the first direction, the upper side is the rear side in the first direction, and the lower side is the front side in the first direction.

As shown in FIG. 1 and FIG. 2, the attachment counterpart 5 is composed of four hollow long members 50 aligned in the vehicle traveling direction and having a longitudinal direction oriented in the vehicle width direction.

Among the four long members 50 constituting the attachment counterpart 5, the two long members 50 located on the front side in the vehicle traveling direction are in contact with each other. Among the four long members 50, the two long members 50 located on the rear side in the vehicle traveling direction are also in contact with each other. Among the four long members 50, the two long members 50 located on the front side in the vehicle traveling direction and the two members 50 located on the rear side in the vehicle traveling direction are spaced apart from each other.

As shown in FIG. 2 and FIG. 5, among the long members 50, the two long members 50 on the front side in the vehicle traveling direction are provided with first fixing counterparts 51, and one long member 50 on the rearmost side in the vehicle traveling direction is provided with a second fixing counterpart 52 and a positioning counterpart 53. The positioning counterpart 53 is located on the front side in the vehicle traveling direction with respect to the second fixing counterpart 52.

As shown in FIG. 2 and FIG. 5, the first fixing counterparts 51 and the second fixing counterpart 52 are spaced apart in the vehicle traveling direction. Therefore, in the console box structure 1 of the embodiment, the vehicle traveling direction is the second direction. Furthermore, the front side in the vehicle traveling direction is the front side in the second direction, and the rear side in the vehicle traveling direction is the rear side in the second direction. The vehicle traveling direction in this specification means a direction in which the vehicle travels during normal traveling, not during reverse traveling.

As shown by solid lines in FIG. 5, the attachment counterpart 5 has four first fixing counterparts 51.

More specifically, among the long members 50, the two long members 50 located on the front side in the vehicle traveling direction, that is, the second direction, are each provided with two first fixing counterparts 51. The respective first fixing counterparts 51 are spaced apart from each other in the vehicle width direction.

The vehicle width direction is considered to be a direction orthogonal to the first direction and the second direction.

Each first fixing counterpart 51 is provided at an upper wall of the long member 50 and has substantially the same through hole shape.

More specifically, each first fixing counterpart 51 has an elongated hole shape that is open upward, that is, on the rear side in the first direction and extends in the second direction.

A rear portion in the second direction of the first fixing counterpart 51 has a diameter that is larger than a front portion thereof and is larger than the outer diameter of a front portion of a first fixing part described later. This portion of each first fixing counterpart 51 is an insertion port 51i into which the first fixing part is inserted.

The attachment counterpart 5 has two second fixing counterparts 52.

The two second fixing counterparts 52 are provided to the one long member 50 located on the rearmost side in the second direction of the long members 50. The respective second fixing counterparts 52 are spaced apart from each other in the vehicle width direction. Of the respective second fixing counterparts 52, the second fixing counterpart 52 on one side in the vehicle width direction is placed on the same straight line extending in the second direction as the first fixing counterparts 51 on the one side in the vehicle width direction among the first fixing counterparts 51. In addition, of the respective second fixing counterparts 52, the second fixing counterpart 52 on the other side in the vehicle width direction is placed on the same straight line extending in the second direction as the first fixing counterparts 51 on the other side in the vehicle width direction among the first fixing counterparts 51.

Each second fixing counterpart 52 is provided at a rear wall of the long member 50 and has an opening facing the rear side in the second direction.

The attachment counterpart 5 further has one positioning counterpart 53 which is open on the rear side in the first direction. The positioning counterpart 53 is provided to the one long member 50 located on the rearmost side in the second direction of the long members 50, together with the two second fixing counterparts 52.

The positioning counterpart 53 is located on the front side of the second fixing counterpart 52 and the rear side of the first fixing counterpart 51 in the second direction and is substantially midway between the two second fixing counterparts 52 in the vehicle width direction.

The positioning counterpart 53 has a substantially quadrangular elongated hole shape extending in the second direction.

As shown in FIG. 1 and FIG. 2, the console box 2 of the console box structure 1 of the embodiment is located on the upper side, that is, on the rear side in the first direction, with respect to the attachment counterpart 5.

The console box 2 has a body part 20, a fixing part 3, and a fastener 4.

The body part 20 has a box shape that is open upward. For reference, the opening of the body part 20 is covered with a lid 29 such that the opening is openable/closable.

As shown in FIG. 2, the fixing part 3 has a first fixing part 31, a second fixing part 32, and a positioning part. The fixing part 3 protrudes from a wall surface located on the front side in the first direction, that is, a bottom wall, of the body part 20 downward, that is, toward the front side in the first direction. The fixing part 3 is integrally molded with the body part 20. The body part 20 and the fixing part 3 are made of a resin.

More specifically, the fixing part 3 has four first fixing parts 31, two second fixing part 32, and one positioning part 33.

Two of the four first fixing parts 31 are located on the front side in the second direction with respect to the other two. The two first fixing parts 31 located on the front side in the second direction are each referred to as first front fixing part 31F, and the two first fixing parts 31 located on the rear side in the second direction are each referred to as first rear fixing part 31R.

The two first front fixing parts 31F are spaced apart from each other in the vehicle width direction. The two first rear fixing parts 31R are also spaced apart from each other in the vehicle width direction.

The first front fixing part 31F on one side in the vehicle width direction of the two first front fixing parts 31F and the first rear fixing part 31R on the one side in the vehicle width direction of the two first rear fixing parts 31R are placed on a straight line extending in the second direction.

Similarly, the first front fixing part 31F on the other side in the vehicle width direction of the two first front fixing parts 31F and the first rear fixing part 31R on the other side in the vehicle width direction of the two first rear fixing parts 31R are placed on a straight line extending in the second direction.

As shown in FIG. 3 and FIG. 4, the first front fixing parts 31F and the first rear fixing parts 31R each have a substantially inverted F-shape and each have a front portion FP, a fixing middle portion MP, and a rear portion RP.

The front portion FP is a portion, located on the front side in the first direction, of each first front fixing part 31F or each first rear fixing part 31R and has a long rod shape extending in the second direction.

The rear portion RP is a portion, located on the rear side in the first direction, of each first front fixing part 31F or each first rear fixing part 31R and has a long rod shape extending in the second direction.

A rear portion in the second direction of the front portion FP and a rear portion in the second direction of the rear portion RP are integrated by the fixing middle portion MP. The fixing middle portion MP has a substantially long plate shape extending from the rear side in the first direction and the rear side in the second direction toward the front side in the first direction and the front side in the second direction.

The distance between the front portion FP and the rear portion RP in the first direction gradually shortens from the front side toward the rear side in the second direction. The shortest distance in the first direction between the front portion FP and the rear portion RP is slightly shorter than the thickness of a peripheral portion of the first fixing counterpart 51 in the first direction in a natural state and is about 90% of this thickness.

As shown in FIG. 3 and FIG. 4, the front portion FP has contact surfaces 31FC which come into contact with the peripheral portion of the first fixing counterpart 51, at one end side, the other end side, and a middle portion therebetween in the vehicle width direction. A portion between the two adjacent contact surfaces 31FC in the front portion FP is recessed, and a reinforcing rib 31FR is provided at the recessed portion so as to protrude upward, that is, toward the rear side in the first direction. The protruding end of the reinforcing rib 31FR is located on the front side in the first direction with respect to the contact surface 31FC.

The rear portion RP also has contact surfaces 31RC which come into contact with the peripheral portion of the first fixing counterpart 51, at one end side, the other end side, and a middle portion therebetween in the vehicle width direction. A portion between the two adjacent contact surfaces 31RC in the rear portion RP is also recessed, and a reinforcing rib 31RR is provided at the recessed portion so as to protrude downward, that is, toward the front side in the first direction. The protruding end of the reinforcing rib 31RR is located on the rear side in the first direction with respect to the contact surface 31RC.

As shown in FIG. 3, each contact surface 31FC of the front portion FP and each contact surface 31RC of the rear portion RP face each other.

The above-described distance between the front portion FP and the rear portion RP in the first direction more specifically means the distance between the contact surface 31FC of the front portion FP and the contact surface 31RC of the rear portion RP.

As shown in FIG. 3, a base portion of the rear portion RP, that is, a rear end portion in the second direction of the rear portion RP, is narrower than an extended end portion of the rear portion RP, that is, a front end portion in the second direction of the rear portion RP. The outer edge of a boundary portion between the base portion of the rear portion RP and the extended end portion of the rear portion RP has a curved shape. Owing to this narrower portion, the first fixing part 31 is easily deformed elastically.

As shown in FIG. 4, the protruding end face of the reinforcing rib 31RR integrally provided on the rear portion RP has an inclined shape that is inclined from the rear side in the second direction and the front side in the first direction toward the front side in the second direction and the rear side in the first direction. In other words, the protruding length of the reinforcing rib 31RR in the first direction gradually shortens from the rear side toward the front side in the second direction. Therefore, the reinforcing rib 31RR does not interfere with the peripheral portion of the first fixing counterpart 51.

The two first front fixing parts 31F have substantially the same shape, and the two first rear fixing parts 31R also have substantially the same shape. As shown in FIG. 3 and FIG. 4, the length of each first front fixing part 31F in the first direction is longer than the length of each first rear fixing part 31R in the first direction.

Furthermore, a front portion in the second direction of each first front fixing part 31F is tapered toward the front side in the second direction and the front side in the first direction.

Specifically, the rear surface of the front portion FP and the rear surface of the fixing middle portion MP of each first front fixing part 31F are each an inclined surface that is inclined from the rear side in the first direction and the rear side in the second direction toward the front side in the first direction and the front side in the second direction.

The rear surface of the fixing middle portion MP of the first rear fixing part 31R is also an inclined surface that is inclined from the rear side in the first direction and the rear side in the second direction toward the front side in the first direction and the front side in the second direction.

As shown in FIG. 2 and FIG. 5, each second fixing part 32 has a substantially plate shape protruding from the bottom wall of the body part 20 toward the front side in the first direction. The second fixing part 32 has two fastening holes 32H in a front portion in the first direction thereof. The two fastening holes 32H are through holes penetrating the second fixing part 32 in the second direction and each have an opening facing in the second direction. The two fastening holes 32H are spaced apart from each other in the vehicle width direction.

The fastener 4 is composed of bolts 40 and nuts 41. Each bolt 40 is inserted into the fastening hole 32H of the second fixing part 32 from the rear side toward the front side in the second direction. Each nut 41 is located on the front side in the second direction with respect to the second fixing part 32 and the front side in the second direction with respect to the second fixing counterpart 52 and is screwed onto a tip portion of the bolt 40.

The positioning part 33 has a clip shape protruding from the bottom wall of the body part 20 toward the front side in the first direction. The positioning part 33 is molded separately from the body part 20 and is assembled to the body part 20 to be integrated with the body part 20. The positioning part 33 is located between the first fixing part 31 and the second fixing part 32 in the second direction.

The attachment work of attaching the console box 2 of the embodiment to the attachment counterpart 5 will be described below.

First, the respective first fixing parts 31 of the console box 2 of the embodiment are attached to the respective first fixing counterparts 51 of the attachment counterpart 5.

The console box 2 is placed on the rear side in the first direction with respect to the attachment counterpart 5. Then, the two first front fixing parts 31F among the first fixing parts 31 of the console box 2 are caused to respectively face the two first fixing counterparts 51 located on the front side in the second direction among the four first fixing counterparts 51 of the attachment counterpart 5.

At this time, furthermore, the two first rear fixing parts 31R among the first fixing parts 31 of the console box 2 are caused to respectively face the two first fixing counterparts 51 located on the rear side in the second direction among the four first fixing counterparts 51 of the attachment counterpart 5.

Then, the front portion FP of each first front fixing part 31F is brought into contact with the corresponding first fixing counterpart 51 from the rear side in the first direction and inserted into the insertion port 51i of the first fixing counterpart 51.

Accordingly, the front portion FP of the first front fixing part 31F enters the insertion port 51i, and a front end portion in the second direction of the front portion FP faces the front side in the second direction on the front side in the first direction with respect to the first fixing counterpart 51.

In this state, the rear portion in the second direction of the console box 2 is tilted downward slightly with the first front fixing part 31F as a center.

Accordingly, the front portion FP of each first rear fixing part 31R faces the corresponding first fixing counterpart 51 from the rear side in the first direction and is inserted into the insertion port 51i of the first fixing counterpart 51. In this state, when the console box 2 is slid toward the front side in the second direction, each first front fixing part 31F and each first rear fixing part 31R face the peripheral portions, on the front side in the second direction, of the corresponding first fixing counterparts 51 from the front side in the first direction.

At this time, the rear portion RP of each first front fixing part 31F and the rear portion RP of each first rear fixing part 31R are both located on the rear side in the first direction with respect to the first fixing counterparts 51 and face the peripheral portions, on the front side in the second direction, of the first fixing counterparts 51 from the rear side in the first direction. Therefore, at this time, each first fixing part 31 sandwiches the peripheral portion of the first fixing counterpart 51 in the first direction by the front portion FP and the rear portion RP.

Since the shortest distance between the front portion FP and the rear portion RP in the first direction is slightly shorter than the thickness of the first peripheral counterpart in the first direction in the natural state, the first peripheral counterpart, that is, the peripheral portion of the first fixing counterpart 51, is elastically sandwiched in the first direction between the front portion FP and the rear portion RP.

Accordingly, each first fixing part 31 is fixed to the attachment counterpart 5 having the first fixing counterparts 51.

Furthermore, at this time, the positioning part 33 of the fixing part 3 faces the positioning counterpart 53 of the attachment counterpart 5 from the rear side in the first direction and is inserted into the positioning counterpart 53. Accordingly, the portion, on the rear side in the second direction, of the fixing part 3 is positioned relative to the attachment counterpart 5.

Furthermore, at this time, each second fixing part 32 is located on the rear side in the second direction with respect to the second fixing counterpart 52 and each fastening hole 32H of the second fixing part 32 faces the second fixing counterpart 52 from the rear side in the second direction.

Therefore, when each bolt 40 of the fastener 4 is inserted into the fastening hole 32H from the rear side in the second direction toward the front side, the tip portion of the bolt 40 enters the second fixing counterpart 52. By screwing the tip portion of the bolt 40 into the nut 41, the peripheral portion of the fastening hole 32H of the second fixing part 32 and the peripheral portion of the second fixing counterpart 52 are fastened together in the second direction by the fastener 4.

Accordingly, each second fixing part 32 is fixed to the attachment counterpart 5 having the second fixing counterparts 52, and the console box 2 of the embodiment is fixed to the vehicle body.

As described above, each first front fixing part 31F has a tapered shape, and the rear surface of the front portion FP and the rear surface of the fixing middle portion MP of the first front fixing part 31F are each an inclined surface that is inclined from the rear side in the first direction and the rear side in the second direction toward the front side in the first direction and the front side in the second direction. In addition, the rear surface of the front portion FP and the rear surface of the fixing middle portion MP are substantially continuous.

Therefore, when the front end of the front portion FP of each first front fixing part 31F is inserted into the corresponding insertion port 51i and the inclined surface of this front portion FP comes into contact with the peripheral portion, on the rear side in the second direction, of the insertion port 51i, the attaching direction of the first front fixing part 31F is naturally guided in the inclination direction of the inclined surface, and the first front fixing part 31F is guided to an appropriate position with respect to the insertion port 51i. Accordingly, each first rear fixing part 31R is also guided to an appropriate position with respect to the corresponding insertion port 51i.

Therefore, for example, even if a worker has difficulty in visually recognizing each first front fixing part 31F and the corresponding insertion port 51i, and each first rear fixing part 31R and the corresponding insertion port 51i, easily performing the work of inserting the first front fixing part 31F and the first rear fixing part 31R into the corresponding insertion ports 51i is possible. Accordingly, easily performing the work of fixing each first fixing part 31 to the attachment counterpart 5 having the first fixing counterparts 51 is possible.

As described above, each first front fixing part 31F is responsible for a function of guiding the attaching direction thereof in an appropriate direction. Therefore, the length of the first front fixing part 31F, more specifically the length of the first front fixing part 31F in the first direction, is designed to be longer than the length of the first rear fixing part 31R in the first direction.

In the console box structure 1 of the embodiment, when attaching the console box 2 to the attachment counterpart 5 of the vehicle body, each first fixing part 31 is first inserted into the first fixing counterpart 51 and slid therein. Then, each bolt 40 of the fastener 4 is inserted into the fastening hole 32H of the second fixing part 32 and the second fixing counterpart 52, and the peripheral portion of the fastening hole 32H of the second fixing part 32 and the peripheral portion of the second fixing counterpart 52 are fastened together by the fastener 4. In the console box structure 1 of the embodiment, the console box 2 is attached to the attachment counterpart 5 of the vehicle body through only two steps. That is, the console box structure 1 of the embodiment has excellent attachment workability of attaching the console box 2 to the vehicle body.

In addition, the console box structure 1 of the embodiment eliminates a console bracket that has been conventionally required, and has a part of an attachment structure for attaching each first fixing part 31, that is, the console box 2, to the vehicle body, and this part is integrated with the console box 2. Such a console box structure 1 of the embodiment has a reduced number of components.

Furthermore, in the console box structure 1 of the embodiment, when attaching the console box 2 to the attachment counterpart 5 of the vehicle body, the console box 2 including the first fixing parts 31 is first slid toward the front side in the second direction. Then, the console box 2 including the second fixing parts 32 is fastened toward the front side in the second direction. As described above, in the console box structure 1 of the embodiment, the sliding direction when fixing each first fixing part 31 to the attachment counterpart 5 and the fastening direction when fixing each second fixing part 32 to the attachment counterpart 5 are the same second direction.

Accordingly, even if the sliding amount of each first fixing part 31 when fixing the first fixing part 31 to the attachment counterpart 5 is not sufficient and the engagement length of the first fixing part 31 with the peripheral portion of the first fixing counterpart 51 is not sufficient, this engagement length becomes sufficient by the first fixing part 31 sliding toward the front side in the second direction during the work of attaching each second fixing counterpart 52 and each second fixing part 32. Therefore, in the console box structure 1 of the embodiment, the work of engaging each first fixing part 31 with the peripheral portion of the first fixing counterpart 51 is easy, and the reliability of this work is also improved.

In addition, in the console box structure 1 of the embodiment, many reinforcing ribs 31RR are provided to the rear portions RP as shown by broken lines in FIG. 5. The reinforcing ribs 31RR protrude from the rear side toward the front side in the first direction and are each extended between the fixing middle portion MP and the bottom wall of the body part 20. The reinforcing ribs 31RR are responsible for a function of transmitting and distributing forces acting on the first fixing parts 31 from the lower side toward the upper side, to the console box 2. Accordingly, the first fixing parts 31 are stably fixed to the attachment counterpart 5 even when an impact occurs.

In the console box structure 1 of the embodiment, the cooperation of these allows the console box 2 to be stably and easily fixed to the vehicle body.

Although the present disclosure has been described above, the present disclosure is not limited to the above-described embodiment, etc., components described in the embodiment, etc., may be optionally extracted and combined to carry out the present disclosure, and various changes may be made without departing from the gist of the present disclosure.

In addition, the specification of the present disclosure discloses not only the citation relationship between the claims as originally filed, but also the technical concept obtained by combining the matters recited in each claim as appropriate.

### DESCRIPTION OF REFERENCE CHARACTERS

1: console box structure (storage structure)

2: console box (storage device)

20: body part

3: fixing part

31: first fixing part

31F: first front fixing part

31R: first rear fixing part

31RR: reinforcing rib of rear portion

32: second fixing part

32H: fastening hole

4: fastener

5: attachment counterpart

51: first fixing counterpart

52: second fixing counterpart

FP: front portion

RP: rear portion

1. A storage structure mounted in a vehicle compartment, the storage structure comprising
an attachment counterpart integrated with a vehicle body and a storage device located on a rear side in a first direction with respect to the attachment counterpart, wherein
the storage device has a body part having a box shape, a fixing part protruding from a bottom wall, located on a front side in the first direction, of the body part, and a fastener,
the fixing part has a first fixing part and a second fixing part spaced apart from the first fixing part in a second direction intersecting the first direction and having a fastening hole with an opening facing in the second direction,
the attachment counterpart has a first fixing counterpart having a through hole shape with an opening facing in the first direction and a second fixing counterpart having a hole shape with an opening facing in the second direction and spaced apart from the first fixing counterpart in the second direction, and
in an attachment state where the storage device is attached to the attachment counterpart,
the first fixing part sandwiches a peripheral portion of the first fixing counterpart in the first direction,
the fastening hole of the second fixing part faces the second fixing counterpart in the second direction, and
a peripheral portion of the fastening hole of the second fixing part and a peripheral portion of the second fixing counterpart are fastened together in the second direction by the fastener.

2. A storage device mounted in a vehicle compartment and located on a rear side in a first direction with respect to an attachment counterpart integrated with a vehicle body, wherein
the attachment counterpart has a first fixing counterpart having a through hole shape with an opening facing in the first direction and a second fixing counterpart having a hole shape with an opening facing in a second direction intersecting the first direction and spaced apart from the first fixing counterpart in the second direction,
the storage device has a body part having a box shape, a fixing part protruding from a bottom wall, located on a front side in the first direction, of the body part, and a fastener,
the fixing part has a first fixing part and a second fixing part spaced apart from the first fixing part in the second direction and having a fastening hole with an opening facing in the second direction, and
in an attachment state where the storage device is attached to the attachment counterpart,
the first fixing part sandwiches a peripheral portion of the first fixing counterpart of the attachment counterpart in the first direction,
the fastening hole of the second fixing part faces the second fixing counterpart of the attachment counterpart in the second direction, and
a peripheral portion of the fastening hole of the second fixing part and a peripheral portion of the second fixing counterpart are fastened together in the second direction by the fastener.

3. The storage device according to claim 2, wherein the fixing part is integrally molded with the body part.

4. The storage device according to claim 2, wherein
the second fixing part is located on a rear side in the second direction with respect to the second fixing counterpart in the attachment state,
the first fixing part has
a front portion extending in the second direction and located on the front side in the first direction with respect to the peripheral portion of the first fixing counterpart in the attachment state, and
a rear portion extending in the second direction and located on the rear side in the first direction with respect to the peripheral portion of the first fixing counterpart in the attachment state,
a distance between the front portion and the rear portion in the first direction gradually shortens from a front side in the second direction toward the rear side in the second direction, and
the peripheral portion of the first fixing counterpart is elastically sandwiched in the first direction between the front portion and the rear portion in the attachment state.

5. The storage device according to claim 4, wherein
the rear portion has a reinforcing rib extending in the first direction, and
a protruding length of the reinforcing rib toward the front side in the first direction gradually shortens from the rear side in the second direction toward the front side in the second direction.

6. The storage device according to claim 4, wherein
the fixing part has two said first fixing parts,
a first front fixing part that is one of the two said first fixing parts is located on the front side in the second direction with respect to a first rear fixing part that is the other of the two said first fixing parts, and
a length of the first front fixing part in the first direction is longer than a length of the first rear fixing part in the first direction.
